(19) United States
(12) Patent Application Publication
(10) Pub. No.: US 2007/0091435 A1
(43) Pub. Date: Apr. 26, 2007

(54) Image pixel transformation

(75) Inventors: Grant K. Garner, Albany, OR (US); Masoud K. Zavarehi, Albany, OR (US); Andrew K. Juenger, Brush Prairie, WA (US); Paul H. McClelland, Monmouth, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/256,011

(22) Filed: Oct. 21, 2005

(51) Int. Cl. G03B 21/60

(52) U.S. Cl. 359/459

(57) ABSTRACT

Various embodiments for image pixel transformation are disclosed.

### BACKGROUND

Display systems may utilize a projector to project an image onto a screen. Ambient lighting, which is also reflected off the screen, may reduce contrast of the image received by an observer.

### BRIEF DESCRIPTION OF THE DRAWINGS

FIG. 1 is a schematic illustration of an example projection system according to an example embodiment.

FIG. 2 is a flow diagram of one example of a method of operation of the projection system of FIG. 1 according to an example embodiment.

FIG. 3 is a flow diagram of one example of a method for transforming luminances of pixels according to one example embodiment.

FIG. 4A is a graph illustrating one example of a transform for transforming pixel target luminances to projection luminances according to one example embodiment.

FIG. 4B is a graph illustrating another example of a transform for transforming pixel target luminances to projection luminances according to example embodiment.

FIG. 4C is graph of another example of a transform for transforming pixel target luminances to projection luminances according to an example embodiment.

FIG. 5 is histogram illustrating distribution of pixel target luminances of an image according to one example embodiment.

FIG. 6 is graph illustrating examples of transforms for transforming pixel target luminances to projection luminances according to an example embodiment.

### DETAILED DESCRIPTION OF EXAMPLE EMBODIMENTS

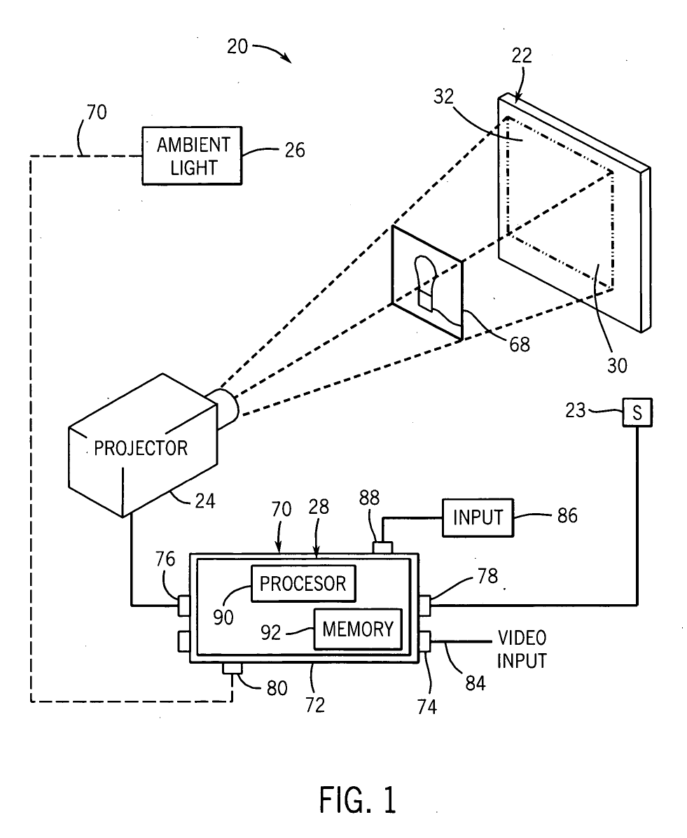

FIG. 1 schematically illustrates one example of a projection system 20 which is configured to transform target luminances of pixels of an image to be projected onto a screen to appropriate projection luminances based upon the reflectivity of the screen and an ambient light value. Projection system 20 transforms the target luminances to projection luminances such that the luminances of such pixels in ambient light closely match the luminances of pixels when viewed with a white Lambertian screen with no ambient light. Projection system 20 facilitates the viewing of the images in the presence of ambient light, such as in a lighted room, while achieving image contrast close to or matching that of an image of viewed in a completely dark or near dark environment, such as in a movie theatre.

Projection system 20 generally includes screen 22, sensors 23, projector 24, ambient light source 26, and controller 28. Screen 22 constitutes a structure having a surface 30 configured to reflect light. Although screen 22 is illustrated as being rectangular, screen 22 may have various sizes, shapes and configurations. Although screen 22 is illustrated as a distinct structure, in other embodiments, screen 22 may be provided by an existing wall or a room, building or other structure or a flexible or inflexible panel or span of material configured to reflect light. Screen 22 may have a known reflectivity R. In other embodiments, the reflectivity R of screen may be sensed or otherwise determined.

Sensors 23 (schematically shown) constitute one or more sensors configured to sense or detect electromagnetic radiation, such as visible light. In a particular example illustrated, sensors 23 are located upon or along surface 30 of screen 22 and are configured to sense light from ambient light source 26 impinging surface 30 as well as light from projector 24 impinging surface 30. Sensors 23 may be utilized to sense or detect light intensity values or brightness values of ambient light source 26 as well as a projection luminance range of projector 24. In particular embodiments, sensors 23 may further be configured to sense or otherwise detect a reflectivity R of screen 22. In other embodiments, sensors 23 may be omitted. If the sensors are not present, the combined reflectivity R and ambient light level may be input manually through a variable knob by the user.

In the particular example illustrated, each of sensors 23 may constitute a commercially available device that is capable of producing an electrical signal proportional to the intensity of incident light. In one embodiment, each of sensors 23 is capable of detecting luminance and not other properties of the light impinging upon sensors 23, or, alternatively, is capable of detecting tristimulus values, x, y and z, where x and z are chrominance parameters and y is a luminance parameter. Examples of sensor 23 include a photo diode or photo transistor, either as a discrete component or built integral to screen 22. The output signal of each sensor 23 is transmitted to controller 28 for use by controller 28 performing image processing.

Projector 24 constitutes a device configured to project visual light towards surface 30 of screen 22 such that the incident of light is reflected from surface 30 and is viewable by an observer. In one embodiment, projector 24 is configured to project color images at screen 22. In other embodiments, projector 24,may be configured to merely project grayscale images. In one embodiment, projector 24 may constitute a digital light processor (DLP). In other embodiments, projector 24 may constitute an interferometric projector or other device configured to project images of light upon screen 22. In other embodiments, projector 24 may be configured to project other wave lengths of electromagnetic radiation such as infrared light or ultraviolet light and the like.

Ambient light source 26 constitutes a source of ambient light for the environment of projector 24 and screen 22. In one embodiment, ambient light source 26 may constitute one or more sources of light that emit visual light such as an incandescent light, a fluorescent light or one or more light emitting diodes. In yet other embodiments, ambient light source 26 may constitute one or more structures that facilitate transmission of light from a source through an opening or window having a source such as sunlight or other light. As indicated by broken lines 70, in some embodiments, ambient light source 26 may be in communication with controller 28, enabling controller 28 to control either the emission or transmission of light by ambient light source 26. In other embodiments, ambient light source 26 may alternatively operate independent of control by controller 28.

Controller 28 is associated with or in communication with the other components of system 20 and configured to direct or control the operation of screen 22 and projector 24. In some embodiments, controller 28 may be additionally configured to direct and control ambient light-source 26. Controller 28 communicates with screen 22 and projector 24 via hard wired electrical or optical lines. In other embodiments, controller 28 may communicate with screen 22 and projector 24 in other fashions such as wirelessly. In one embodiment, controller 28 may be physically embodied as part of projector 24. In still other embodiments, controller 28 may be physically embodied in separate units associated with projector 24. In yet other embodiments, controller 28 may be physically embodied as one or more separate units that may be selectively connected to screen 22.

In the embodiment illustrated, controller 28 generally includes processor 90 and memory 92. Processor 90 constitutes a processing unit configured to analyze input and to generate output to facilitate operation of projection system 20. For purposes of the disclosure, the term “processor unit” shall include a presently available or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 28 is not limited to any specific combination of hardware circuitry and software, nor to any particular source for the instructions executed by the processing unit.

In the particular embodiment illustrated, processor 90 analyzes input such as input from light sensors 23, and video input 84. Video input 84 generally constitutes data or information pertaining to one or more images to be displayed by projection system 20. In particular, video input 84 includes data or information regarding individual pixels or portions of an image. In one embodiment, video input 84 may include a single frame of image data for a still image. In yet another embodiment, video input 84 may include information for multiple frames of image data for displaying multiple still images or displaying motion pictures or movies.

For each pixel, video input 84 represents a target luminance value T desired for the pixel. The target or ideal pixel luminance T is the amount of light desired to be reflected from a given pixel in the image from a white Lambertian screen in a dark room with no ambient light. Such target luminances Tᵢⱼ (for a pixel having coordinates i, j in an image) range from a zero or black value to a one or white value. In embodiments where at least portions of the image to be displayed by projection 20 are to be in color, video input 84 may additionally include information regarding color values for each pixel. For example, video input 84 may include information coded for RGB or the YCbCr video standards. In embodiments where the projected image is to be a grayscale image or a black and white image, such color information may be omitted.

Video input 84 may be provided to controller 28 from various sources. For example, video input 84 may be transmitted to controller 28 wirelessly or through optical or electrical wiring. Video input 84 may be transmitted to controller 28 from a source such as a live video or broadcast or another external device configured to read image data from a storage medium such as a magnetic or optical tape, a magnetic or optical disc, a hardwired memory device or card or other form of persistent storage. Such image data may also alternatively be provided by another processor which generates such image data. In some embodiments, controller 28 itself may include a currently developed or future developed mechanism configured to read image data from a portable memory containing such image data such as a memory disc, memory tape or memory card.

According to one embodiment, controller 28 is physically embodied as a self-contained unit 70. For example, in one embodiment, controller 28 may be physically embodied as a box which may be connected to projector 24. In such an embodiment, controller 28 may be replaced or upgraded without corresponding replacement of projector 24. In such an embodiment, controller 28 may be provided as an upgrade to existing projectors 24 to facilitate enhanced projection quality.

In the embodiment illustrated, unit 70 includes a housing or enclosure 72, and external interfaces 74, 76, 78, and 80. Housing 72 surrounds and contains the electronic componentry of controller 28.

Interfaces 74-80 facilitate communication between controller 28, contained within housing 72, and external devices. In a particular embodiment illustrated, processor 90 is in communication with each of interfaces 74-80. Such interfaces 74-80 are configured to facilitate both the reception of information from and the communication of information to external devices. In a particular embodiment illustrated, interface 74 is configured to receive video input 84 for processing by controller 28. Interface 76 is further configured to facilitate communication of information to projector 24. In one embodiment, interface 76 is specifically configured to facilitate communication of projection luminances P of image pixels to projector 24.

Interface 78 is configured to facilitate communication between controller 28 and sensors 23.

Interface 80 is configured to facilitate communication between controller 28 and ambient light source 26. In one embodiment, interface 80 facilitates communication of control signals from controller 28 to ambient light source 26 to control provision of ambient light by ambient light source 26. In some embodiments where control of ambient light source 26 is not exercised, interface 80 may be omitted.

As further shown by FIG. 1, in one embodiment, projection system 20 may additionally include input 86 configured to facilitate input of instructions or information to controller 28 by an observer or operator of system 20. For example, input 86 may be utilized to facilitate input of an ambient light value which may be used by controller 28 in lieu of sensed ambient light values otherwise provided by sensors 23 or other sensors. Input 86 may constitute a keyboard, mouse, touch pad touch screen, one or more buttons, switches, and voice recognition or voice recognition software and the like. In the particular embodiment shown, input 86 communicates with processor 90 of controller 28 via external interface 88 along housing 72. In other embodiments, input 86 may be physically incorporated into housing 72. In other embodiments, input 86 and interface 88 may be omitted.

In the particular embodiment shown, interface 74-80 and 88 constitute outlets or plugs supported by housing 72 along external faces of housing 72 along one or more external faces of housing 72, wherein the outlets or plugs mate with corresponding electrical wires or optical fibers associated with external devices. In yet other embodiments, interfaces 74-80 and 88 may include wireless receivers or transmitters configured to facilitate wireless communication with external devices. In embodiments where controller 28 is incorporated as part of projector 24 or as part of screen 22, housing 72 and interfaces 74-80 may be omitted.

Memory 92 constitutes one or more computer readable mediums configured to store and contain information or data such as instructions for directing the operation of processor 90 and image frame data received from video input 84. In one embodiment, memory 92 contains written instructions for directing processor 92 to analyze information from screen 22, projector 24 and ambient light source 26. In one embodiment, memory 92 further contains instructions for directing processor 90 to generate controls based upon the analysis of such information, wherein screen 22, projector 24 and ambient light source 26 operate in a desired manner in response to such control signals. In yet another embodiment, memory 92 contains memory buffer to hold the current image data received from input video 84 for processing.

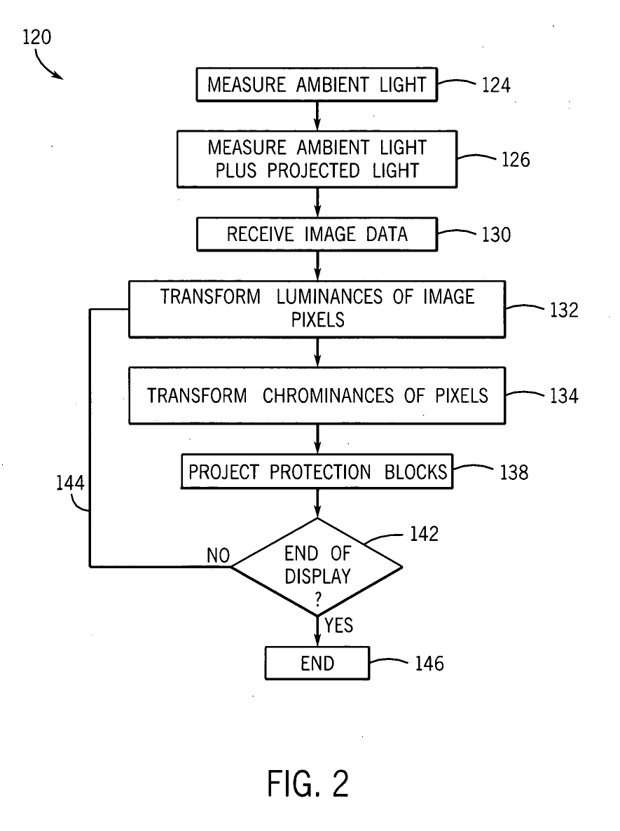

FIG. 2 is a flow diagram illustrating one example of a method 120 of operation of project system 20. As indicated by step 124 in FIG. 2, ambient light from ambient light source 126 is measured. Based upon the sensed or input ambient light value, projection system 20 adjusts the operation of projection 24 and screen 22 to compensate for the ambient light value. In one embodiment, processor 90, following instructions contained in memory 92, generates control signals directing sensors 23 to sense ambient light levels proximate to screen 22. In other embodiments, sensors 23 may be configured to continuously sense and transmit signals representing ambient light levels to processor 90. In still other embodiments, ambient light may be sensed or measured using other sensing devices other than sensors 23. In still other embodiments, in lieu of sensing ambient light, ambient light values may be input or otherwise provided to projection system 20 by an operator or user of projection system 20 through input 86 or from an external device in communication with controller 28. In one embodiment, ambient light values that are used by controller 28 to direct the operation of projector 24 and screen 22 may be manually input by rotating in input knob or actuating some other manual input mechanism. For example, by turning a knob or other mechanical input device, an operator may input an estimate of the amount of ambient light intensity until he or she sees the most desireable image quality on screen 22. In another embodiment, one of a reflectance or an ambient light value or level may be manually input. In still other embodiments, a manual adjustment could select between combinations of both without having to spell out the specific values of either.

As indicated by step 126, projection system 20 measures or senses ambient light plus projected light. In one embodiment, controller 28 generates control signals directing projector 24 to project a selected luminance level of white light upon screen 22. Sensors 23 transmit signals representing the ambient light plus the projected light to controller 28. As a result, controller 28 may quantify the level of ambient light in terms of the intensity of light projected by projector 24. For example, controller 28 may generate control signals directing projector 24 to project white light at its highest luminance level towards screen 22. As a result, sensors 23 sense a greatest luminance that may be provided to an image pixel reflected off of screen 22. Based upon the sensed or input ambient light value obtained in step 122 and its quantification relative to light projected from projector 24, and a selected reflectivity of one or more regions 32 of screen 22, projection system 20 compensates for the ambient light to enhance image contrast.

As indicated bystep 130 in FIG. 2, controller 28 receives image data or video input 84 (shown in FIG. 1). Upon receiving such video input, as indicated by step 132 in FIG. 2, controller 28 adjusts, modifies or otherwise transforms target luminances T of image pixels to projection luminances P in each projection block 220. In particular, controller 32 transforms the target luminances of pixels to projection luminances based upon the reflectivity of screen, and the sensed or input ambient light value to closely match the luminances of pixels in the projection with ambient light to viewed luminances of the pixels when viewed with a white Lambertian screen with no ambient light.

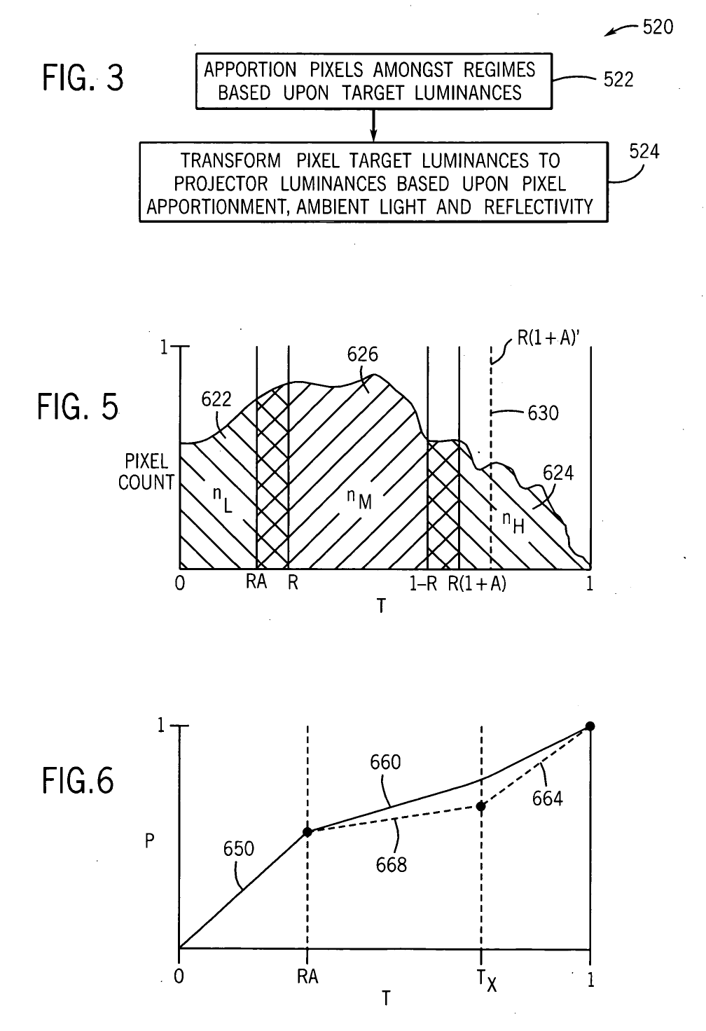

FIG. 3 is a flow diagram illustrating one example method 520 by which controller 28 (shown in FIG. 1) may transform target luminances T of image pixels to projection luminances P in projection area 68 (shown in FIG. 1). As indicated by step 522 in FIG. 3, controller 28, following instructions contained in memory 92, analyzes and compares the target luminance T of each image pixel so as to apportion such pixels amongst multiple groupings or regimes based upon their target luminances T. In one embodiment, the pixels are apportioned amongst regimes based upon their target luminances T, the selected reflectivity R of screen 22 and the ambient light value A.

As indicated by step 524 in FIG. 3, upon determining in which regime an individual pixel of an image block may belong, controller 24 applies an algorithm or formula to adjust, modify or otherwise transform the target luminance T of the individual pixel to a projector luminance P based upon the regime in which the pixel belongs (pixel apportionment), the ambient light value A and the reflectivity R for the screen 22.

The transformation of the target luminance T to projector luminance P for each pixel is also based upon a range of luminance levels that may be provided by projector 24. In this manner, the available luminance levels of projector 24 are apportioned amongst the target luminances T of the different pixels. Because available luminance levels of projector 24 are apportioned amongst pixels based upon their target luminances, the ambient light value and the reflectivity R of screen 22, contrast between pixels having different target luminances T in a projection block in the presence of ambient light may be closely matched to contrast between target luminances T of individual pixels of a projection block had there been no ambient light and had such pixels been reflected off a white Lambertian screen. Thus, projection system 20 (shown in FIG. 1) operate according to the example method 520 in FIG. 3, facilitates viewing of images in the presence of ambient light, such as in a lighted room, while achieving image contrast close or matching that of an image viewed in a completely dark or near dark environment, such as in a movie theater.

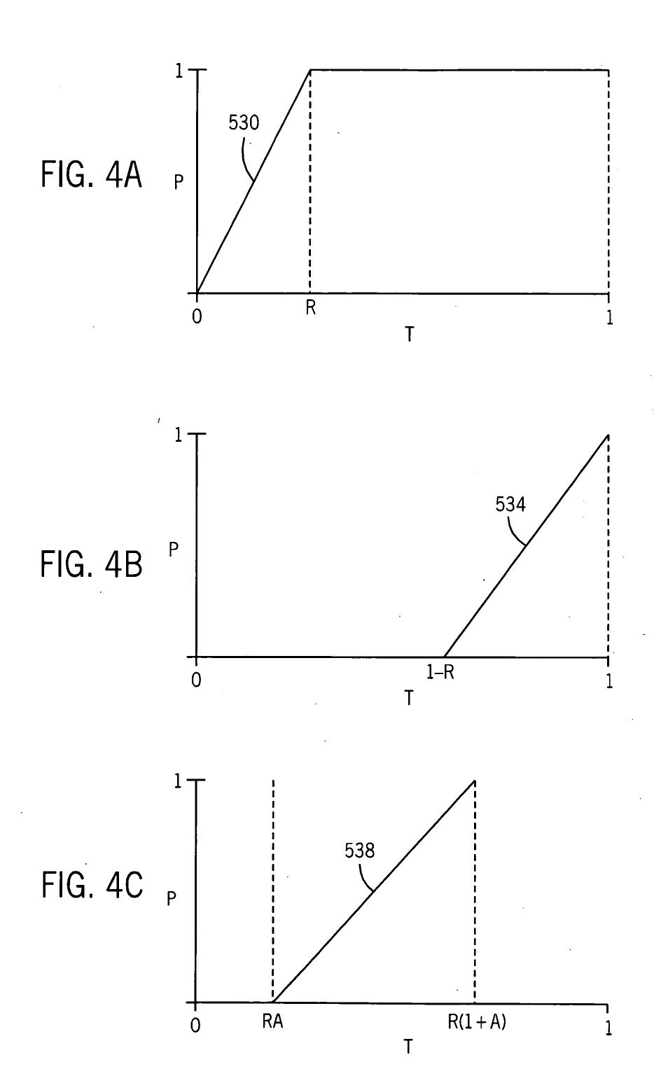

FIGS. 4A-4C illustrate one example of apportioning pixels amongst regimes based upon their target luminances T and transforming such target luminances T to projector luminances P based upon what particular regime the target luminances T of a pixel may lie, a reflectivity R of screen 22, the available luminance levels or range provided by projector 24 and the ambient light value A. As shown in each of FIGS. 4A-4C, target luminances T are scaled or otherwise set so as to range from a 0 (black) value to a 1 (white) value. The target luminance T is the amount of light reflected from a given pixel in an image from a white Lambertian screen in a dark room.

In each of FIGS. 4A-4C, the projection luminance P represents the amount of light projected by projector 24 for a given pixel and is scaled or otherwise set to range from a 0 (black) value to a 1 (white) value. The 1 (white) value represents the greatest amount of luminance that may be projected by projector 24. For example, a projection luminance P of 0.5 would generally mean that projector 24 is projecting light for a given pixel with a luminance level of 50% of the greatest luminance that may be provided by projector 24 at the particular pixel. The greatest achievable projection luminance that may be provided by projector that is used to transform the target luminances to projection luminances may be the value provided by the manufacturer of projector 24 or may be some other value established by the user for projection system 220 of projection system 20.

For purposes of the method and algorithm illustrated with respect to FIGS. 4A-4C, the reflectivity R of a particular screen region 32 is a value relative to a white Lambertian screen, wherein a 0 value is black and wherein a 1 value is that of a white Lambertian screen. The ambient light A associated with the particular screen region 32 is the amount of light, relative to projector white, not coming from the projected image. For purposes of the method described with respect to FIGS. 4A-4C, the ambient light value A is scaled or otherwise set so as to range from a 0 value representing no ambient light (i.e., a dark room) to a greatest value of 1 which has the same luminance or amount of light as that of the greatest available luminance that may be projected by projector 24 (P equals 1).

According to one embodiment, the scaling of the ambient light value A relative to available luminance levels of projector 24 is performed in steps 124 and 126 of method 120 shown in FIG. 2. In particular, the greatest projection luminance provided by projector 24 is determined by subtracting the measured ambient light obtained in step 124 from the value obtained in step 126 representing both ambient light plus projected light. This greatest projected luminance of projector 24 is scaled to 1. The same conversion rate applied to light projected by projector 24 to scale the greatest projection light to a value of 1 is then applied to the ambient light value. For example, if an ambient light value of 40 was sensed in step 124 and a value of 240 was sensed for ambient light plus projected light, controller 28 (shown in FIG. 1) would subtract the ambient light value 40 from the combined ambient and projected light value of 240 to determine that the greatest projected luminance level of projector 24 is 200. To scale greatest projection luminance level 200 value to a value of 1, controller 28 would multiply the greatest projection luminance level of 200 by 0.005. Likewise, the ambient light value of 40 would also be multiplied by 0.005 such that the ambient light value used (1) to apportion the pixels of a projection block amongst different regimes or classifications, (2) to potentially transform target luminances to projection luminances and (3) to potentially select a reflectivity R for a particular screen region 32 would be 0.2 (40 multiplied by 0.005). In other methods, such scaling of the ambient light value A to available projection luminance levels of projector 24 may be omitted.

As shown by FIGS. 4A-4C, target luminances T of pixels are apportioned amongst three classifications or regimes operating under the presumption that the darkest that a region 32 of screen 22 may get is when the projector 24 is turned off. In such a scenario, screen 22 is illuminated only by ambient light and not projector light and reflects such ambient light, without reflecting projector light, such that the display or observed luminance or brightness P is RA. Further operating under the presumption that the brightest the screen can get is when the projector is fully on (P=1), the display or reflected luminance is R×(1+A). Based on such presumptions, for a given screen reflectivity R, three luminance regimes are used:

(1) those pixels having target luminance values T which should be darker than the screen in the presence of ambient light can obtain (T<R×A);

(2) those pixels whose target luminances T can be matched by projector 24 and screen 22 in the presence of ambient light (T=R(P+A)); and

(3) those pixels having target luminances which are brighter than screen 22 and projector 24 in the presence of ambient light can obtain (T>R×(1+A)).

FIG. 4A illustrates one example scenario in which each of the pixels in area 68 (shown in FIG. 1) have a target luminance T which is darker than ambient light A that is reflected from region 32 of screen 22 having a reflectivity R, (T<R×A). In the scenario illustrated in FIG. 4A, the transform 530 is applied to the target luminances T to convert or transform such target luminances T to appropriate projection luminances P. Transform 530 ramps the luminance levels of projector 24 to account for the reflectivity R of the screen 22 and the ambient light A that is reflected from region 32 or screen 22. In the particular example illustrated, transform 530 is formulated as:
Pᵢⱼ=Tᵢⱼ/R, where:
Pᵢⱼ=a projection luminance for an image pixel have coordinates i, j;
Tᵢⱼ=target luminance of image pixel having coordinates i, j; and
R=reflectivity of the screen,and
A=ambient light reflected off the screen.
In other embodiments, transform 530 may comprise another formulation.

FIG. 4B illustrates an example scenario in which the target luminances T of each of the pixels of a projection block 220 are brighter than what can be attained by the reflectivity R of screen 22 and the light projected by projector 24 in the presence of ambient light provided by light source 26 (T>R(1+A)). In such a scenario, the target luminances of each of the pixels is converted or transformed to a projection luminance using transform 534. Transform 534 boosts the range of target luminances T accounting for reflectivity. In one embodiment, transform 534 may be formulated as follows:
Pᵢⱼ=1−1/R+Tᵢⱼ/R, where:
Pᵢⱼ=a projection luminance for an image pixel have coordinates i, j,
R=reflectivity of the screen; and
Tᵢⱼ=target luminance of image pixel having coordinates i, j.
In yet other embodiments, transform 534 may have other formulations.

FIG. 4C illustrates an example scenario in which each of the pixels of a projection block 220 have target luminances T that can be matched by the light projected from projector 24, the reflectivity R of screen 22 and the ambient light A reflected from screen 22 (T=R(P+A)). In such a scenario, controller 28 (shown in FIG. 1) transforms the target luminances T of each of pixels to projection luminances P using transform 538. Transform 538 apportions available projection luminance levels of projector 24 amongst the different pixels based upon the target luminances of such pixels. In one embodiment, transform 538 is formulated as follows:
Pᵢⱼ=Tᵢⱼ/R−A, where:
Pᵢⱼ=a projection luminance for an image pixel have coordinates i, j,
Tᵢⱼ=target luminance of an image pixel having coordinates i, j;
R=reflectivity of the screen; and
A=light value.
In other embodiments, transform 538 may have other formulations.

FIGS. 5 and 6 illustrate one example process by which the target luminances of pixels in a projection area 68 are transformed to projection luminances in a scenario wherein the target luminances of the pixels in the particular projection frame or area 68 are distributed amongst multiple regimes. In particular, FIGS. 5 and 6 illustrate one example method of transforming target luminances to projection luminances where the target luminances of pixels is distributed in each of the regimes described above with respect to FIGS. 4A, 4B and 4C. Because the target luminances of the pixels distributed or otherwise fall into these different regions or regimes, the transforms 530, 534 and 538 described with respect to FIGS. 4A, 4B and 4C are combined. In one embodiment, the different transforms 530, 534 and 538 are combined based upon the distribution of the pixels amongst the regimes. In one embodiment, this is done by counting to determine the proportion of pixels in each of the regimes. Based upon the determined proportion of pixels in each regime, the slope of each transform 530, 534 and 538 is scaled by a function of the proportion of pixels in the associated regime. Subsequently, the scaled transforms are stacked together.

FIG. 5 is a histogram illustrating one example distribution of pixels in a particular projection frame or area 68 (shown in FIG. 1) having target luminances T in each of regimes 622, 624 and 626. Similar to the particular regime illustrated in FIG. 4A, regime 622 in FIG. 5 includes pixels having target luminances ranging from a zero luminance to a luminance value corresponding to the reflectivity R of screen 22 (shown in FIG. 1). Similar to the regime depicted in FIG. 4B, regime 624 in FIG. 5 includes those pixels having target luminances ranging from a luminance value of 1 down to a luminance value of 1 minus the reflectivity R of screen 22. Similar to the regime depicted in FIG. 4C, regime 626 of FIG. 5 includes those pixels having target luminances T ranging from a luminance value equal to the reflectivity R of the screen 22 multiplied by the ambient light value A up to a luminance value equal to a reflectivity R of screen 22 multiplied by the sum of 1 plus the ambient light value A for screen 22. As shown by FIG. 5, in some cases, regimes 622, 624 and 626 may-overlap. As indicated by alternative lower boundary line 630 which corresponds to a luminance value R(1+A)′, in some embodiments, the values for R and A may be such that a gap exists between the alternative lower boundary 630 of regime 624 and the upper boundary of regime 626.

In one embodiment, the number of pixels within each regime are counted. Due to the overlapping of the boundaries of such regimes, some pixels in overlapping regions are counted twice, once for both of the overlapping regimes. In other embodiments, the upper and lower boundaries of regime 626 may be used to also define the upper boundary of region 622 and the lower boundary of regime 624, respectively. However, using the lower and upper boundaries of regimes 626 as the upper and lower boundaries of regime 622 and 624, respectively, has been found to over-emphasize light portions of an image to the detriment of darker portions. In scenarios where a gap exists between the lower boundary of regime 624 and the upper boundary of regime 626, those pixels contained in the gap are not counted for the purpose of scaling transforms 530, 534 and 538. In other embodiments, such pixels contained in such gaps may be apportioned to regime 624 and/or regime 626.

FIG. 6 illustrates the combining or stacking of transforms 530, 534 and 538 (shown and described with respect to FIGS. 4A, 4B and 4C) as scaled based upon a distribution of target luminances amongst the different regimes. As shown by FIG. 6, transform 650 is applied to those pixels having a target luminance T less than the lower boundary of regime 626 (shown in FIG. 6) which is the reflectivity R of screen 22 multiplied by the ambient light level A. Because transform 650 is applied to pixels having target luminances less than the lower bound of regions 626 rather than the upper bound of regime 622, a greater number of pixels may be assigned projection luminances P that are more closely matched to the target luminances given the presence of ambient light in a non-Lambertian screen. Transform 650 is similar to transform 530 (shown in FIG. 4A) except that transform 650 is scaled based upon the proportion of pixels amongst the various regimes. In one embodiment, transform 650 is formulated as follows:
Pᵢⱼ=N_{L}Tᵢⱼ/R for 0≦Tᵢⱼ≦RA, where:
N_{L}=F(n_{L}/n_{TOT}),
n_{L}=number of pixels whose target luminances Tᵢⱼ are less than the reflectivity of the screen region 32,
n_{TOT}=total number of image pixels,
R=reflectivity of the screen region 32; and
Tᵢⱼ=target luminance of image pixel having coordinates i, j.

As noted above, N_{L} is equal to a function F of n_{L}/n_{TOT}. In one embodiment, the function F is a power of the percentage of total pixels within regime 622. As a result, a particular weighting may be given to the percentage of pixels within region 622 for image quality. In the particular example illustrated, N_{L} equals (n_{L}/n_{TOT})^{0.75}. In other embodiments, other powers and other weightings may be given to the percentage of pixels having target luminances within the regime 622. In still other embodiments, transform 650 may have other formulations.

As further shown by FIG. 6, pixels having target luminances T greater than the reflectivity R of screen 22 multiplied by the ambient light A are transformed to projection luminances P using transform 660. In the particular embodiment illustrated, transform 660 constitutes a combination of transforms 534 and 538 (shown and described with respect to FIGS. 4B and 4C) after such transforms have been sloped based upon the distribution of pixel target luminances T. In one embodiment, transform 660 constitutes a cubic spline of scaled transforms 534 and 538. In one embodiment, transform 660 may be formulated as follows:
Pᵢⱼ(Tij)=aTᵢⱼ³+bTᵢⱼ²+cTᵢⱼ+d for RA≦Tᵢⱼ≦1, where
P(RA)=N_{L}A
P′(RA)=N_{M}/R,
P(1)=1,
P′(1)=N_{H}/R,
N_{L}=F(n_{L}/n_{TOT})
n_{L}=number of pixels whose target luminances Tᵢⱼ are less than the reflectivity of the screen,
N_{M}=F(n_{M}/n_{TOT}),
n_{M}=number of pixels whose target luminances Tᵢⱼ are greater than RA and less than R(1+A),
N_{H}=F(n_{H}/n_{TOT}),
n_{H}=number of pixels whose target luminances Tᵢⱼ are greater than 1−R,
n_{TOT}=total number of pixels,
R=reflectivity of the screen,
Tᵢⱼ=target luminance of a pixel having coordinates i, j, and
A=a light value.
   This results in a system of four equations and four unknowns that may be easily solved to compute the transform.

As noted above, in one embodiment, N_{M} is a function F of n_{M}/n_{TOT}. In one embodiment, the function F is a power of n_{M}/n_{TOT} so as to appropriately weight the percentage of pixels having target luminance T within regime 626. In one embodiment, transform 660 utilizes a value for N_{M} equal to (n_{M}/n_{TOT})^{0.667}. As noted above, transform 660 also utilizes a value for N_{H} equal to a function F of (n_{H}/n_{TOT}). In one embodiment, the function F is a power of n_{H}/n_{TOT}so as to appropriately weight the percentage of pixels having target luminances T within regime 624. In one embodiment, transform 660 has a value for N_{H}equal to (n_{H}/n_{TOT})^{√2}. It has been found that such weighting provides improved image quality. In other embodiments, transform 660 may utilize other powers or other functions of the percentages of pixels having target luminances in regime 626 or 624.

In some embodiments where transforms 534 and 538 (shown and described with respect to FIGS. 4B and 4C), as scaled and combined, intersect one another at point Tₓ, distinct transforms 664 and 668 (shown in broken lines) may alternatively be applied to transform target luminance values T of pixels to projection luminance values P. For example, in one embodiment, transforms 534 and 538 (shown in FIGS. 4B and 4C) may intersect at point Tₓ which may be defined as follows:
Tₓ=R(1+(N_{M}−N_{L})A−N_{H})/(N_{M}−N_{H}), where:
N_{L}=F(n_{L}/n_{TOT}),
n_{L}=number of pixels whose target luminances Tᵢⱼ are less than the reflectivity of the screen,
N_{M}−F(n_{M}/n_{TOT}),
n_{M}=number of pixels whose target luminances Tᵢⱼ are greater than RA and less than R(1+A),
N_{H}=F(n_{H}/n_{TOT}),
n_{H}=number of pixels whose target luminances Tᵢⱼ are greater than 1−R,
n_{TOT}=total number of pixels,
R=reflectivity of the screen,
Tᵢⱼ=target luminance of a pixel having coordinates i, j, and
A=a light value.

In such a scenario, pixels having target luminances T greater than the reflectivity R of screen 22 multiplied by the ambient light value A but less the value Tₓ are transformed to projection luminances P according to transform 668 which may be formulated as follows:
Pᵢⱼ=N_{L}A+((N_{H}/R)(Tₓ−1)+1−N_{L}A)(Tᵢⱼ−AR)/(Tₓ−AR) for RA≦Tᵢⱼ≦Tₓ, where:
N_{L}=F(n_{L}/n_{TOT}),
n_{L}=number of pixels whose target luminances Tᵢⱼ are less than the reflectivity of the screen,
N_{M}=F(n_{M}/n_{TOT}),
n_{M}=number of pixels whose target luminances Tᵢⱼ are greater than
RA and less than R(1+A),
N_{H}=F(n_{H}/n_{TOT}),
n_{H}=number of pixels whose target luminances Tᵢⱼ are greater than 1−R,
n_{TOT}=total number of pixels,
R=reflectivity of the screen,
Tᵢⱼ=target luminance of a pixel having coordinates i, j,
A=a light value, and
Tₓ=R(1+(N_{M}−N_{L})A−N_{H})/(N_{M}−N_{H}).

For those pixels having target luminances T greater than Tₓ, the target luminances T of such pixels are transformed to projection luminances P using transform 664 which may be formulated as follows:
Pᵢⱼ=1−N_{H}/R+N_{H}Tᵢⱼ/R=for Tₓ≦Tᵢⱼ≦1, where
N_{L}=F(n_{L}/n_{TOT})
n_{L}=number of pixels whose target luminances Tᵢⱼ are less than the reflectivity of the screen,
N_{M}=F(n_{M}/n_{TOT}),
n_{M}=number of pixels whose target luminances Tᵢⱼ are greater than RA and less than R(1+A),
N_{H}=F(n_{H}/n_{TOT}),
n_{H}=number of pixels whose target luminances Tᵢⱼ are greater than 1−R.
n_{TOT}=total number of pixels,
R=reflectivity of the screen,
Tᵢⱼ=target luminance of a pixel having coordinates i, j,
A=a light value, and
Tₓ=R(1+(N_{M}−N_{L})A−N_{H})/(N_{M}−N_{H}).

As noted above, both transforms 664 and 668 utilize functions F of n_{L}/n_{TOT}, n_{M}/n_{TOT}and n_{H}/n_{TOT}. In one embodiment, the functions applied constitute powers to appropriately weight the percentage of pixels in regimes 624 and 626. In one embodiment, transforms 664 and 668 utilize values wherein N_{L} is equal to (n_{L}/n_{TOT})^{0.5} and wherein N_{M} is equal to (n_{M}/n_{TOT})^{0.667} and wherein N_{H}is equal to (n_{H}/n_{TOT})^{√2} to appropriately weight pixels for image quality. In other embodiments, the function F applied to the percentage of pixels within regime 624 and 626 may constitute other functions, other powers or may be omitted.

By apportioning pixels among regimes based upon their target luminances T and by transforming such pixel target luminances T to projector luminances P based upon such pixel apportionment, ambient light A and reflectivity R of screen 22, method 520 (shown in FIG. 3) may closely match actual viewed luminances of such pixels in the projection in the presence of ambient light to near ideal conditions where viewed luminances of pixels are viewed with a Lambertian screen and no ambient light.

In other embodiments, method 520 may transform pixel target luminances T to projector luminances P using other transforms as well as using other factors in addition to or besides pixel apportionment, ambient light and reflectivity. Moreover, in lieu of closely matching viewed luminances of pixels in a projection with ambient to viewed luminances of pixels when viewed with a Lambertian screen and no ambient light, method 520 may alternatively utilize one or more transforms for closely matching perceived brightnesses of pixels in a projection with ambient light to viewed perceived brightnesses of pixels when viewed with a Lambertian screen without ambient light. Perceived brightness of an image may be defined as a logarithmic function of a luminance value for the same pixel. In another embodiment, wherein the perceived brightness of pixels in a projection with ambient are to be closely matched to viewed perceived brightness of pixels when viewed with a Lambertian screen without ambient light, the same transforms 530, 534, 538 or 650, 660, 664 and 668 may be utilized by transforming target luminances T to projection luminances P using an logarithmic value of the target luminance T of each pixel rather than the target luminance T itself of each pixel. For example, instead of using target luminance T, a transform may alternatively use a logarithmic function of target luminance T to calculate a perceived brightness of the projector luminance P. Once this is calculated, the inverse of the logarithmic function is applied to the result of the transform to once again arrive at the projector luminance P, and control signals are generated directing a projector to provide the particular pixel with the projector luminance P. In other embodiments, other transforms using logarithmic values of target luminances T to calculate projection luminances P may be utilized.

As indicated by step 134 in FIG. 2, method 120 further transforms chrominances or color values of pixels in each projection block 220 based upon the particular reflectivity value R of the associated screen region 32 and the ambient light value A associated with the screen region 32 upon which the particular projection block 220 is aligned and to be projected upon. By transforming or adjusting chrominances of pixels in each block based upon the selected reflectivity and ambient light for the associated screen region 32, method 120 reduces the likelihood of colors becoming washed out by such ambient light. In one embodiment, such color compensation is performed using color components in CIELAB 76 coordinates to maintain the same hue while increasing chromaticity in proportion to the increase in luminance as a result of ambient light. In one embodiment, the chrominance of pixels are adjusted or transformed according to the following:
a*(Pᵢⱼ)=fᵢⱼa*(Tᵢⱼ) and b*(Pᵢⱼ)=fᵢⱼb*(Tᵢⱼ), where:
fᵢⱼ=(L*(R(Pᵢⱼ+A))/(L*(R(Tᵢⱼ+A))) which is approximately equal to the {cube root}\sqrt{(Pᵢⱼ+A)/(Tᵢⱼ+A);}
R=reflectivity of the screen,
A=a light value,
Pᵢⱼ=a projection luminance P of a pixel having coordinates ij, and
Tᵢⱼ=target luminance of a pixel having coordinates ij.

As a result, since CIELAB is based on the cube roots of XYZ tri-stimulus values:
X′ᵢⱼ=({cube root}\sqrt{Pᵢⱼ}+fᵢⱼ({cube root}\sqrt{Xᵢⱼ}−{cube root}\sqrt{Tᵢⱼ}))³; and
Z′ᵢⱼ=({cube root}\sqrt{Pᵢⱼ}=fᵢⱼ ({cube root}\sqrt{Zᵢⱼ}−{cube root}\sqrt{Tᵢⱼ}))³ for each pixel.
   In other embodiments, other mappings of the gamut may be utilized.

As indicated by step 138 in FIG. 2, upon transformation of pixel luminance and chrominance values, controller 28 directs projector 24 (shown in FIG. 1) it projects the image pixels towards screen 22. As indicated by step 142, controller 28 determines from video input 84 (shown in FIG. 1) whether the image or images being displayed are at an end, such as when a single still image is to be displayed or such as when an end of a video or animation has been completed. If additional frames or images are to, be subsequently projected upon screen 22, as indicated by arrow 142, steps 132, 134 and 138 are once again repeated for the subsequent image or frame that would be projected as projection area 68. Otherwise, as indicated by arrow 144, method 120 is completed.

Overall, method 120 (shown and described with respect to FIG. 2) facilitates improved viewing of a projected image in the presence of ambient light. Steps 124-132 facilitate transformation of target luminances of image pixels based upon the reflectivity for the screen 22 and the ambient light value sensed or input. Step 134 enables chrominances of such pixels to be transformed or adjusted to maintain the same hue while increasing their chromaticity in proportion to the luminance adjustments made in step 132.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An method comprising:
transforming target luminances of image pixels to projection luminances using a light value and a reflectivity of a projection screen.

2. The method of claim 1, wherein the transforming of the target luminances of each of the image pixels uses target luminances of other of the image pixels.

3. The method of claim 2, wherein the transforming of the target luminances uses a distribution of the target luminances of the image pixels.

4. The method of claim 1, wherein the transforming is based on available luminance levels of a projector.

5. The method of claim 4, wherein the available luminance levels of the projector are apportioned amongst the target luminances of the image pixels.

6. The method of claim 1, further comprising sensing an ambient light value, wherein the light value includes the ambient light value.

7. The method of claim 1, further comprising inputting an ambient light value, wherein the light value includes the ambient light value.

8. The method of claim 1, further comprising selecting an ambient light value, wherein the light value includes the ambient light value.

9. The method of claim 1, wherein the image pixels are assigned into regimes using target luminances of the image pixels, the light value and the reflectivity of the screen.

10. The method of claim 9, wherein a first one of the regimes has an upper boundary equal to the reflectivity of the screen.

11. The method of claim 10, wherein the target luminances of pixels in the first one of the regimes are transformed according to the following:
Pᵢⱼ=1−1/R+Tᵢⱼ/R, where:
Pᵢⱼ=a projection luminance for an image pixel have coordinates i, j,
R=reflectivity of the screen; and
Tᵢⱼ=target luminance of image pixel having coordinates i, j.

12. The method of claim 9, wherein a first one of the regimes has a lower bound equal to the reflectivity of the screen multiplied by the light value and an upper bound equal to the reflectivity of the screen plus the reflectivity of the screen multiplied by the light value.

13. The method of claim 12, wherein the target luminance of pixels in the first one of the regions are transformed according the following:
Pᵢⱼ=Tᵢⱼ/R, where:
Pᵢⱼ=a projection luminance for an image pixel have coordinates i, j,
Tᵢⱼ=target luminance of image pixel having coordinates i, j; and
R=reflectivity of the screen.

14. The method of claim 9, wherein a first one of the region has an upper bound equal to one white Lambertian and a lower bound equal to one white Lambertian less the reflectance of the screen.

15. The method or claim 14, wherein the target luminance of the pixels in the first one of the regimes is transformed according to the following:
Pᵢⱼ=Tᵢⱼ/R−A, where:
Pᵢⱼ=a projection luminance for an image pixel have coordinates i, j,
Tᵢⱼ=target luminance of an image pixel having coordinates i, j;
R=reflectivity of the screen; and
A=a light value.

16. The method of claim 9, further comprising applying different transforms to the target luminances of image pixels in different regimes to transform the target luminances to projection luminances.

17. The method of claim 16, wherein the different transforms are scaled using a relative distribution of the target luminances of the image pixels among the regimes.

18. The method of claim 17, wherein the transforms are scaled using a percentage of total target luminances in each regime.

19. The method of claim 18 wherein the transforms are scaled using a different power of the percentage of the total target luminances in each regime.

20. The method of claim 1, wherein target luminances of image pixels are transformed to projection luminances according to the following:
Pᵢⱼ=N_{L}Tᵢⱼ/R for 0≦Tᵢⱼ<RA, where:
N_{L}=F(n_{L}/n_{TOT}),
n_{L}=number of pixels whose target luminances Tᵢⱼ are less than the reflectivity of the screen,
N_{TOT}=total number of image pixels,
R=reflectivity of the screen; and
Tᵢⱼ=target luminance of a pixel having coordinates i, j.

21. The method of claim 1, wherein target luminances of image pixels are transformed to projection luminances according to the following:
Pᵢⱼ(Tij)=aTᵢⱼ³+bTᵢⱼ²+cTᵢⱼ+d for RA≦Tᵢⱼ≦1, where
P(RA)=N_{L}A
P′(RA)=N_{M}/R,
P(1)=1,
P′(1)=N_{H}/R,
N_{L}=F(n_{L}/n_{TOT}),
n_{L}=number of pixels whose target luminances Tᵢⱼ are less than the reflectivity of the screen,
N_{M}=F(n_{M}/n_{TOT}),
n_{M}=number of pixels whose target luminances Tᵢⱼ are greater than R×A and less than R(1+A),
N_{H}=F(n_{H}/n_{TOT}),
n_{H}=number of pixels whose target luminances Tᵢⱼ are greater than 1−R,
n_{TOT}=total number of pixels,
R=reflectivity of the screen,
Tᵢⱼ=target luminance of a pixel having coordinates ij, and
A=a light value.

22. The method of claim 1, further comprising adjusting color components of the image pixels using transformation of the target luminances to projection luminances of the image pixels.

23. The method of claim 1, wherein transforming further comprises transforming target luminances of image pixels to target brightnesses of image pixels, transforming the target brightnesses to projection brightnesses and transforming projection brightnesses to the projection luminances.

24. The method of claim 1, wherein the target luminances of image pixels are transformed to projection luminances according to the following:
Pᵢⱼ=N_{L}A+((N_{H}/R)(Tₓ−1)+1−N_{L}A) (Tᵢⱼ−AR)/(Tₓ−AR) for RA≦Tᵢⱼ≦Tₓ, where:
N_{L}=F(n_{L}/n_{TOT});
n_{L}=number of pixels whose target luminances Tᵢⱼ are less than the reflectivity of the screen,
N_{M}=F(n_{M}/n_{TOT}),
n_{M}=number of pixels whose target luminances Tᵢⱼ are greater than RA and less than R(1+A),
N_{H}=F(n_{H}/n_{TOT}),
n_{H}=number of pixels whose target luminances Tᵢⱼ are greater than 1−R,
n_{TOT}=total number of pixels,
R reflectivity of the screen,
Tᵢⱼ=target luminance of a pixel having coordinates ij,
A=a light value, and
Tₓ=R(1+(N_{M}−N_{L})A−N_{H})/(N_{M}−N_{H}).

25. The method of claim 1, wherein target luminance of pixels are transformed to projection luminances according to the following:
Pᵢⱼ=1−N_{H}/R+N_{H}Tᵢⱼ/R for Tₓ≦Tᵢⱼ≦1, where:
N_{L}=F(n_{L}/n_{TOT}),
n_{L}=number of pixels whose target luminances Tᵢⱼ are less than the reflectivity of the screen,
N_{M}=F(n_{M}/n_{TOT}),
n_{M}=number of pixels whose target luminances Tᵢⱼ are greater than RA and less than R(1+A),
N_{H}=F(n_{H}/n_{TOT}),
n_{H}number of pixels whose target luminances Tᵢⱼ are greater than 1−R.
n_{TOT}=total number of pixels,
R=reflectivity of the screen,
Tᵢⱼ=target luminance of a pixel having coordinates ij,
A=a light value, and
Tx=R(1+(N_{M}−N_{L})A−N_{H})/(N_{M}−N_{H}).

26. A computer readable medium comprising:
instructions to transform target luminances of image-pixels to projection luminances using a light value and a reflectivity of a screen.

27. An apparatus comprising:
a controller configured to transform target luminances of image pixels to projection luminances using a light value and a reflectivity of a screen.

28. The apparatus of claim 27, further comprising a projector.

29. A method comprising:
obtaining a reflectivity of a surface upon which an image is to be projected;
obtaining a light value; and
a step for closely matching perceived brightness of pixels in a projection with ambient light to viewed perceived brightness of pixels when viewed with a white Lambertian screen without ambient light.

30. A method comprising:
obtaining a reflectivity of a surface upon which an image is to be projected;
obtaining a light value; and
a step for closely matching viewed luminances of pixels in a projection with ambient light to viewed luminances of pixels when viewed with a white Lambertian screen without ambient light.
